(19) United States
(12) Patent Application Publication
(10) Pub. No.: US 2008/0317964 A1
(43) Pub. Date: Dec. 25, 2008

(54) High Temperature Lubricant Compositions and Methods of Making the Same

(76) Inventors: Rocco Vincent Burgo, Mullica Hill, NJ (US); Paulson Kolangaden, Belle Mead, NJ (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/815,494

(22) PCT Filed: Feb. 10, 2006
(86) PCT No.: PCT/US06/04965

§ 371 Date: Apr. 18, 2008

Related U.S. Application Data
(60) Provisional application No. 60/651,733, filed on Feb. 10, 2005.

(51) Int. Cl. C10M 105/36; C08G 63/16; B05D 1/02; B05D 1/28; B05D 1/18

(52) U.S. Cl. 427/427.5; 528/302; 508/496; 508/482; 508/480; 427/435; 427/429

(57) ABSTRACT

A high temperature lubricant composition for lubricating conveyored oven chains and other high temperature applications comprises at least one polyol polyester polymer and optionally at least one additive. The polyol polyester polymer can be made from esterification of at least one polyol, at least one dicarboxylic acid and at least one monocarboxylic acid. Optionally, at least one polyol polyester, at least one extreme pressure/antiwear agent and/or at least one metal deactivator is added to the final lubricant composition. The lubricant has a kinematic viscosity @40° C. of from about 50 to about 1,000 centistokes, a viscosity index of at least about 140, and a flash point of at least about 270° C. The lubricants have low evaporation loss, high resistance to oxidation, and provide reduction of friction when used in high temperature lubricant applications. Methods of applying the composition to conveyored oven chains include, but are not limited to, spraying, dipping, brushing, manually applying and combinations thereof.

### CROSS REFERENCE TO RELATED PATENT APPLICATIONS

The present application claims priority under to U.S. Provisional Patent Application Ser. No. 60/651,733, filed Feb. 10, 2005, the entirety of which is hereby incorporated by reference.

### FIELD OF INVENTION

This invention relates generally to lubricant compositions useful for high temperature applications, and particularly to lubricants for oven chain oil applications comprising polyol polyester polymers.

### BACKGROUND OF INVENTION

Conveyored oven chain systems are currently required in many industrial applications such as food baking, fiberglass production, wood laminating, wood pressing, paint curing, and textile production. In these applications, chains are exposed to high temperatures typically exceeding 200° C. Lubricants that can withstand these high temperatures are essential, and must provide sufficient lubrication of the chain to prevent wear of the chain, and to reduce friction that leads to lower energy consumption.

Lubricants that are used at high temperatures must also be resistant to oxidative and/or thermal breakdown, and polymerization. Breakdown, in which scission of the lubricant molecule occurs, leads to the formation of lower molecular weight volatile compounds. Evaporation of these compounds can causes changes in viscosity, oil loss, and the production of excessive smoke. This can lead to poorer lubrication, higher cost, reduced cleanliness of the plant, poorer product quality, and higher occupational exposure to organic compounds. Polymerization will lead to formation of insoluble gums and varnishes that can build up on the chain and in the work environment, which can lead to production stoppage due to the need to remove deposits from the chain and from the oil application system.

Generally, current lubrication methods employed consist of dry lubrication technology such as the application of suspensions of graphite in a volatile solvent, and liquid lubrication through the use of more thermally stable organic lubricants. In dry lubrication, graphite typically builds up on the chain over time that results in a loss of lubrication. In systems lubricated using this method, production stoppage due to the need to remove graphite deposits from the chain is currently excessive. Although this method is still employed, it is more recently being replaced by liquid lubrication technology. Using liquid lubrication technology, the lubricant is applied by either a dip, spray (manual or automated), or fully manual method such as brushing.

Liquid lubricants typically have a base oil to which other additives are provided. The additives impart specific properties to the overall lubricant mixture. One such class of such additives is metal protecting additives. These exhibit beneficial properties such as resistance to wear, protection from extreme pressure, and resistance to corrosion. One drawback of metal protecting additives, however, is that they can reduce the stability of the base oils once added. To improve the stability, lubricant protecting additives can be used to help the lubricant maintain its structure under operational conditions. The most important lubricant protecting additives are antioxidants. Antioxidants protect a base oil in a lubricant composition and/or other additives therein from attack by atmospheric oxygen, a harmful process also known as oxidation which produces free radicals and leads to instability. Antioxidants help to stabilize lubricants by helping to prevent oxidation. The effectiveness of antioxidants is strongly influenced by the level of inherent stability of the base oil or oils in the composition. Greater stability of the base oil helps to reduce potentially adverse effects of oxidation.

Base oils employed in liquid lubrication systems currently generally consist of either mixtures of mineral oil and/or synthetic hydrocarbons with synthetic esters, or are totally synthetic ester based. Due to their lower cost, mineral oil or synthetic hydrocarbon/ester blends are often used in lower temperature applications. For higher temperature, more severe applications, the base oil is normally based totally on synthetic esters, typically based on neopentyl polyol chemistry.

Since the operational temperature of the lubricant is generally very high, the neopentyl polyol polyesters normally employed are high in viscosity when measured at 40° C. High viscosity is required to prevent the oil from dripping off of the chain once the chain reaches operating temperature. Typically, the viscosity of the lubricants are from 68 to 460 centistokes when measured at 40° C. In order to obtain these higher viscosities, the higher molecular weight neopentyl polyols need to be employed to form the neopentyl polyol polyester. These neopentyl polyols are typically monopentaerythritol, dipentaerythritol, and tripentaerythritol, with the predominant component normally being dipentaerythritol. The carboxylic acids used to form the esters typically consist of linear and/or branched chain compounds containing from about five to about twelve carbon atoms. Shorter chain length carboxylic acids are preferred because thermal stability normally decreases as carbon chain length increases. In order to obtain the higher viscosity needed for high temperature applications, a predominant proportion of branched chain carboxylic acids are normally required. Particularly useful branched chain acids are 2-ethylhexanoic acid and 3,5,5-trimethylhexanoic acid (isononanoic acid.)

For example, the ester of dipentaerythritol with isononanoic acid has a viscosity of about 350 centistokes when measured at 40° C. Unfortunately, higher branching in the carboxylic acid portion of the molecule leads to a greater tendency for the viscosity to change with changes in temperature, which means the viscosity index (VI) is low. The VI is a property that measures the tendency for the viscosity of a lubricant to change with temperature. In this system, the higher the VI, the less the viscosity of the lubricant will decrease with increasing temperature. Since the operational temperature in oven chain applications far exceeds 40° C., higher VI is a significant advantage since higher viscosity provides better lubrication.

Thus, often times a viscosity index improver is utilized to increase the viscosity of the lubricant. It has been discovered that the use of viscosity index improvers such as Paratone® and others, however, are susceptible to shear and thermal degradation at high temperatures. Viscosity index improvers in addition exhibit high friction characteristics, even when metal protecting additives are utilized. Such characteristics are not desirable in high temperature lubricant compositions. Thus, it would be useful for the polyol polyester used as the base oil not only to respond favorably to metal protecting additives, but also to be inherently high in viscosity and viscosity index.

To obtain the high viscosity required for high temperature applications, often times polyol polyesters must be derived from branched chain monofunctional carboxylic acids. It has been found that the lubrication properties, and particularly the ability of the lubricant to reduce friction is reduced in proportion to the amount and type of branching in the carboxylic acid portion of the neopentyl polyol polyester. It has also been found that esters formed from longer chain carboxylic acids exhibit improved friction reducing behavior. To obtain acceptably high viscosity and acceptably low friction, polyols can be reacted with polyfunctional carboxylic acids and monofunctional carboxylic acids to form polyol polyester polymers. These polyol polyester polymers are also known in the art as complex esters. A significant problem, however, is that polyol polyester polymers formed from longer chain dicarboxylic acids such as dimer acids are susceptible to oxidative attack. Thus, complex esters based upon dicarboxylic acids that contain long linear and unsaturated carbon chains are not suitable for severe temperature applications as they tend to form excessive deposits, even when lubricant protecting additives are employed.

Therefore, there is a need in the art for an improved high temperature lubricant composition.

### SUMMARY OF INVENTION

Accordingly, the present invention is an improved high temperature lubricant composition comprising polyol polyester polymers that exhibits desirable viscosity, viscosity temperature behavior, oxidation resistance, and friction reduction.

More specifically, the present invention is an improved lubricant comprising an improved base oil, that when combined with certain metal protecting and/or lubricant protecting additives combines the oxidative stability and low deposit formation tendency provided by the use of a base oil comprising the reaction of neopentyl polyols with shorter chain carboxylic acids, the high viscosity provided by the reaction of neopentyl polyols with branched chain carboxylic acids, and the lower friction that has been associated with the use of longer chain carboxylic acids to form polyol polyester polymers.

Thus, in one aspect, the present invention is a high temperature lubricant composition that includes a polyol polyester polymer made from the reaction of at least one neopentyl polyhydric alcohol, at least one dicarboxylic acid and at least one monocarboxylic acid.

In another aspect, the present invention is a high temperature lubricant composition that includes a polyol polyester polymer made from the reaction of at least one neopentyl polyhydric alcohol containing from 3 to 8 hydroxyl groups, at least one dicarboxylic acid containing 3 to 8 carbon atoms and at least one monocarboxylic acid. In another embodiment, the monocarboxylic acid contains from 5 to 12 carbon atoms.

In another aspect, the present invention is a high temperature lubricant composition that includes a) a polyol polyester polymer made from the reaction of at least one polyhydric alcohol, at least one dicarboxylic acid and at least one monocarboxylic acid, and b) at least one high temperature additive. In one embodiment, the high temperature additive is an antioxidant, an extreme pressure/antiwear agent, a metal deactivator, or a combination thereof.

In yet another aspect, the present invention is a high temperature lubricant composition that includes a) a polyol polyester polymer made from the reaction of at least one neopentyl polyhydric alcohol, at least one dicarboxylic acid and at least one monocarboxylic acid, b) at least one high temperature additive and c) at least one polyol polyester.

Another aspect of the present invention is a high temperature lubricant composition that includes a polyol polyester polymer made from the reaction of at least one polyhydric alcohol, at least one dicarboxylic acid and at least one monocarboxylic acid, where the lubrication composition has a kinematic viscosity at 40° C. of from about 50 to about 1,000 centistokes, a viscosity index of at least about 140, and a flash point of at least about 270° C.

In another aspect, the present invention is a high temperature lubricant composition that includes a polyol polyester polymer made from the reaction of at least one neopentyl polyhydric alcohol, at least one dicarboxylic acid containing from 3 to 8 carbon atoms and at least one monocarboxylic acid. In one embodiment, the polyhydric alcohol is an aliphatic polyfunctional alcohol, a saturated polyfunctional alcohol, a branched polyfunctional alcohol, or a combination thereof. In another embodiment, the dicarboxylic acid is an aliphatic difunctional carboxylic acid, an aromatic difunctional carboxylic acid, a cyclic difunctional carboxylic acid, or a combination thereof. In yet another embodiment, the monofunctional carboxylic acid is an aliphatic linear monofunctional carboxylic acid containing from 5 to 12 carbon atoms, 2-ethylhexanoic acid, or a combination thereof.

In another aspect, the present invention is a high temperature lubricant composition that includes a polyol polyester polymer made from the reaction of at least one neopentyl polyhydric alcohol, at least one dicarboxylic acid containing from 3 to 8 carbon atoms and at least one monocarboxylic acid, where the polyol polyester polymer is present at a level from about 1 to about 90 percent by weight of the lubricant composition, and is formed from the reaction of trimethylolpropane, monopentaerythritol, dipentaerythritol, and tripentaerythritol with at least one carboxylic acid containing from 5 to 12 carbon atoms.

In yet another aspect, the invention is a method of lubricating a conveyored oven chain the a) providing the aforementioned high temperature lubricant composition and b) applying the aforementioned high temperature lubricant composition to the conveyored oven chain. In one embodiment, the lubricant composition is sprayed, dipped, brushed, or manually applied to the conveyored oven chain.

In another aspect, the present invention is a process for producing a high temperature lubricant composition by a) providing a polyol polyester polymer obtained by the reaction of a neopentyl polyhydric alcohol, dicarboxylic acid and monofunctional carboxylic acid, in the presence of a metal catalyst and activated charcoal, at a temperature between about 180° C. and about 250° C.; b) purifying the polyol polyester polymer through steam distillation and filtration; and c) adding a high temperature additive. In one embodiment, the polyhydric alcohol contains from 3 to 8 hydroxyl groups, the dicarboxylic acid contains from 3 to 8 carbon atoms and the monocarboxylic acid contains from 5 to 12 carbon atoms. In another embodiment, the polyol polyester polymer is present at a level from about 1 to about 90 percent by weight of the lubricant composition, and is formed from the reaction of trimethylolpropane, monopentaerythritol, dipentaerythritol, and tripentaerythritol with at least one carboxylic acid containing from 5 to 12 carbon atoms. In yet another embodiment, the lubricant composition has a kinematic viscosity at 40° C. of from about 50 to about 1,000 centistokes, a viscosity index of at least about 140, and a flash point of at least about 270° C.

It is to be understood that both the foregoing general description and the following detailed description are exemplary, but are not restrictive, of the invention.

### DETAILED DESCRIPTION OF THE INVENTION

The present invention provides an improved lubricant composition that exhibits desirable viscosity, viscosity temperature behavior, oxidation resistance, flash point, anti-wear behavior, and friction reduction. Accordingly, in one embodiment, the present invention is an improved lubricant composition for use in high temperature applications comprising a base oil consisting of a liquid polyol polyester polymer formed from the reaction of at least one neopentyl polyol, at least one dicarboxylic acid, and at least one monofunctional carboxylic acid. In a preferred embodiment, the polyol polyester polymer has a viscosity of from about 50 centistokes to about 1000 centistokes when measured at 40° C., a viscosity index of at least about 140, and flash point of at least about 270° C.

The polyol polyester polymer base oils are derived from polyols (i.e., neopentyl polyhydric alcohols), dicarboxylic acids and monocarboxylic acids. Properties of these polyol polyester polymers such as viscosity, viscosity temperature behavior, oxidation resistance, evaporation loss, hydrolytic stability, and flash point can be modified by selection of the polyol, dicarboxylic acid, and monocarboxylic acids used to prepare the polyol polyester polymer, and by the manufacturing process employed.

In a preferred embodiment, the polyhydric alcohol is a neopentyl polyol with at least 3 hydroxyl groups. However, in one embodiment, the polyhydric alcohol is not so limited and can have any suitable number of hydroxyl groups. In a preferred embodiment, the polyhydric alcohol is neopentyl, and has about 3 to about 8 hydroxyl groups. Readily, commercially available polyols of this type are trimethylolpropane, trimethylolethane, pentaerythritol, dipentaerythritol, tripentaerythritol, and tetrapentaerythritol. Preferred polyols are monopentaerythritol and trimethylolpropane or combinations thereof, although minor quantities of dipentaerythritol, tripentaerythritol, and tetrapentaerythritol may be utilized depending upon the commercial availability of pure monopentaerythritol.

The dicarboxylic acid, in one embodiment, has about 3 to about 10 carbon atoms. In a preferred embodiment, the dicarboxylic acid has about 3 to 8 carbon atoms. The most preferred dicarboxylic acid is adipic acid (hexanedioic acid). Preferred dicarboxylic acids include but are not limited to hexanedioic acid, phthalic acid, isophthalic acid, terephthalic acid, dihydropththalic acid, tetrahydrophthalic acid, and cyclohexanedicarboxylic acid or combinations thereof.

Preferred monocarboxylic acids are linear and contain from about 5 to about 12 carbon atoms, and/or 2-ethylhexanoic acid. Monocarboxylic acids having between about 5 to about 12 carbon atoms includes but is not limited to pentanoic acid, hexanoic acid, heptanoic acid, octanoic acid, nonanoic acid, decanoic acid, and mixtures thereof. While in some embodiments, in invention comprises reacting one monocarboxylic acid, one dicarboxylic acid and one polyol, it is understood that a mixture of one or more monocarboxylic acids, one or more dicarboxylic acids and one or more polyols can also be used in carrying out the reaction.

To form the final lubricant composition, at least one other material can be added, which would include but not be limited to a high temperature additive or a polyol polyester. In one embodiment, the additive comprises at least one antioxidant present at a level from about 0.1 to about 6 percent by weight of the final lubricant composition. In a preferred embodiment, the antioxidant is present at a level from about 0.5 to about 4 percent by weight of the final lubricant composition. The antioxidant can include but is not limited to amines such as benzenamine, N-phenyl-, reaction products with 2,4,4-trimethylpentane; N-phenyl-1,1,3,3-tetramethylbutylnaphthalen-1-amine; butylated hydroxytoluene; alkylated diphenylamine; nonylated diphenylamine; styrenated diphenylamine; hindered alkylphenols; benzenepropanoic acid, 3,5-bis(1,1-dimethylethyl)-4-hydroxy-, thiodi-2,1-ethanediyl ester; benzenepropanoic acid, 3,5-bis(1,1-dimethylethyl)-4-hydroxy-, 2,2-bis[[3-[3,5-bis(1,1-dimethylethyl)-4-hydroxyphenyl]-1-oxopropoxy]methyl]-1,3-propanediyl ester; thiphenolic derivatives, and combinations thereof.

Other additives such as an extreme pressure/antiwear agent can be added to form the final lubricant composition. At least one extreme pressure/antiwear agent can be added at between about 0.05 and about 3 percent of the final lubricant composition. In a preferred embodiment, the extreme pressure/antiwear agent is present at a level from about 0.1 to about 2 percent by weight of the final lubricant composition. The extreme pressure/antiwear agent can include but is not limited to t-butylphenyl phosphates, amines, C11-14-branched alkyl, monohexyl and dihexyl phosphates, isopropylphenylphoshates; tricresyl phosphates, trixylyl phosphates, di(n-octyl)phosphite, alkylated triphenylphosphorothionate, triphenylthiophosphate and combinations thereof.

Likewise, at least one metal deactivator can be added as an additive to form the final lubricant composition. In one embodiment, the metal deactivator typically is present at a level from between about 0.01 and about 5 percent by weight of the final lubricant composition. In a preferred embodiment, the metal deactivator is present at a level from about 0.05 to about 1 percent by weight of the final lubricant composition. The metal deactivator can include but is not limited to benzotriazole and tolyltriazole.

Only one of the high temperature additives need be present in the final lubricant compositions, but any mixture of two or more of the high temperature additives can be added as desired. In addition, it is preferred that final lubricant composition is capable would be approved for direct food contact applications.

In a preferred embodiment, the reaction process is an esterification reaction, and such reaction can be carried out in the presence of catalysts. The use of catalysts, however, is optional and the esterification reaction need not be carried out in the presence of a catalyst. In one embodiment, polyol polyester polymer is made from reacting a polyol, dicarboxylic acid and monofunctional carboxylic acid in the presence of a metal catalyst and activated charcoal between about 180° C. and about 250° C., followed by steam distillation and filtration. While the steam distillation and filtration of the reaction product is used for purification purposes, it is understood that other generally accepted purification process can also be used.

In the examples included herein, kinematic viscosity was tested using ASTM (American Society of Testing and Materials, West Conshohocken, Pa., USA) official method number D-445-97 (1997), viscosity index (VI) was determined using ASTM D-2270, flash point was determined using ASTM D-92, and evaporation loss using ASTM D-972. Frictional and antiwear properties were determined using the four-ball method under ASTM D-4172 and the Falex method under ASTM D-2670. Oxidation resistance was measured under ASTM D-4636 and ASTM D-2272. These methods are incorporated herein by reference.

For example, oven chain oil A (“OCL A”) is a yellow liquid with a viscosity of about 236.9 centistokes at about 40° C., about 26.4 centistokes at about 100° C., a viscosity index of about 148, a flash point exceeding about 290° C., and an evaporation loss of less than about 1% when measured after about 6½ hours at about 204° C. OCL A can be used in oven chain oil applications at temperatures up to about 280° C.

### EXAMPLE A

The base oil for the formulation of OCL A was prepared by combining the following materials in a batch reactor fitted with a mechanical stirrer, inert gas sparge, vapor column, condenser, and distillate receiver. Pressure in the reactor was controllable by attaching a vacuum pump to the system.

| Component | Parts Per 100 Parts | Moles Per 100 Parts |
|---|---|---|
| Pentaerythritol | 20.6 | 0.151 |
| Adipic Acid | 12.7 | 0.087 |
| Octanoic Acid | 35.6 | 0.247 |
| Decanoic Acid | 29.1 | 0.169 |

To the reaction mixture, about 0.25 parts per 100 parts activated charcoal were added and the mixture was heated to from about 180° C. to about 250° C. Pressure was slowly reduced until sufficient conversion was obtained. The crude ester was further purified by steam distillation and filtration. The result was a light yellow liquid possessing the following properties:

| Property | Test Method | Result |
|---|---|---|
| Kinematic Viscosity@40° C., cSt | ASTM D-445 | 220 |
| Kinematic Viscosity@100° C., cSt | ASTM D-445 | 26.6 |
| Viscosity Index | ASTM D-2270 | 155 |
| Flash Point, ° C. | ASTM D-92 | 306 |
| Evaporation Loss, % | ASTM D-972 | 0.5 |

All properties indicate that this base oil is suitable for high temperature lubrication applications.

### EXAMPLE B

The final lubricant OCL A was prepared by combining the base oil described in Example A with additives in the following proportions:

| Component | Parts Per 100 |
|---|---|
| Base Oil | 96.6 |
| Antioxidants | 2.5 |
| Antiwear Agent | 0.8 |
| Metal Deactivators | 0.1 |

The base oil was added to a stirred vessel and heated to about 80° C. to about 90° C. in which the additives were combined and agitated until a clear solution was obtained.

### EXAMPLE C

The lubricant composition of the invention OCL A was tested to determine its suitability for high temperature applications. All test methodology was based upon ASTM methods and has been described previously. The following results were obtained:

| Property | Test Method | Result |
|---|---|---|
| Kinematic Viscosity@40° C., cSt | ASTM D-445 | 236.9 |
| Kinematic Viscosity@100° C., cSt | ASTM D-445 | 26.4 |
| Viscosity Index | ASTM D-2270 | 148 |
| Flash Point, ° C. | ASTM D-92 | 297 |
| Evaporation Loss, % | ASTM D-972 | 0.97 |
| Four-Ball Wear, 75° C., 40 kg load, | ASTM D-4172 | 0.37 |
| 1200 rpm, one hour, mm | | |
| Rotating Bomb Oxidation Test | ASTM D-2272 | 900 |
| (RBOT), at 150° C., min. | | |

### EXAMPLE D

The lubricant composition of the invention OCL A was tested under ASTM D-4636, “Oxidation and Corrosion Stability Test” for 72 hours at 204° C. The following results were obtained.

| Property | Result |
|---|---|
| Evaporation Loss, % | 1.13 |
| Sediment, mg/100 mL | 3.4 |
| Test Cell Appearance | Lightly Stained |
| Oil Appearance | Dark Amber |
| Viscosity Change, % | +27.06 |
| TAN Change, mg KOH/g | 0.48→0.89 |
| Metal Wt. Change, | |
| mg/cm2/Appearance | |
| Magnesium | +0.008/Shiny Tan |
| Aluminum | 0.000/Shiny |
| Steel | +0.008/Shiny |
| Copper | −0.116/Shiny |
| Silver | −0.008/Shiny |

The results indicate that OCL A is suitable for high temperature applications possessing low change in viscosity, low sediment, low evaporation loss, and corrosion protection.

### EXAMPLE E

Frictional characteristics of OCL A were evaluated and compared to a conventional ester based oil. Both the OCL A and the conventional ester base oil contained identical additive systems. The conventional ester was based upon dipentaerythritol with branched and linear carboxylic acids. The oils were evaluated utilizing ASTM D-2670, “Falex Pin & V Block Tooth Wear Test Procedure.” Test specimens were AISI 3135 steel pins and AISI C-1137 steel vee blocks. Duration of the test was about five minutes under about 250 pound gauge load followed by about fifteen minutes at about 700 lb gauge load. The FIGURE below shows the coefficient of friction as a function of time during the test.

The test results indicate a significant reduction in friction observed for the OCL A oil as compared to the dipentaerythritol ester based oil.

The present invention may be embodied in other specific forms without departing from the spirit or essential attributes thereof and, accordingly, reference should be made to the appended claims, rather than to the foregoing specification, as indicating the scope of the invention.

What is claimed is:

1. A high temperature lubricant composition comprising a polyol polyester polymer that is a reaction product of at least one neopentyl polyhydric alcohol, at least one dicarboxylic acid containing from 3 to 8 carbon atoms and at least one monocarboxylic acid.

2. The lubricant composition of claim 1, wherein the neopentyl polyhydric alcohol contains from 3 to 8 hydroxyl groups.

3. The lubricant composition of claim 1, wherein the dicarboxylic acid comprises hexanedioic acid.

4. The lubricant composition of claim 1, wherein the neopentyl polyhydric alcohol contains from 3 to 8 hydroxyl groups, the dicarboxylic acid contains from 3 to 8 carbon atoms and the monocarboxylic acid contains from 5 to 12 carbon atoms.

5. The lubricant composition of claim 1, further comprising at least one high temperature additive.

6. The lubricant composition of claim 5, wherein the high temperature additive comprises at least one antioxidant.

7. The lubricant composition of claim 5, wherein the high temperature additive comprises at least one extreme pressure/antiwear agent.

8. The lubricant composition of claim 5, wherein the high temperature additive comprises at least one metal deactivator.

9. The lubricant composition of claim 1, further comprising at least one polyol polyester.

10. The lubricant composition of claim 1, wherein the lubrication composition has a kinematic viscosity at 40° C. of from about 50 to about 1,000 centistokes, a viscosity index of at least about 140, and a flash point of at least about 270° C.

11. The lubricant composition of claim 1, wherein the neopentyl polyhydric alcohol is selected from the group consisting of aliphatic polyfunctional alcohols, saturated polyfunctional alcohols, and branched polyfunctional alcohols.

12. The lubricant composition of claim 1, wherein the dicarboxylic acid is selected from the group consisting of aliphatic difunctional carboxylic acid, aromatic difunctional carboxylic acid, and cyclic difunctional carboxylic acid.

13. The lubricant composition of claim 1, wherein the monofunctional carboxylic acid is selected from the group consisting of aliphatic linear monofunctional carboxylic acid containing from 5 to 12 carbon atoms and 2-ethylhexanoic acid.

14. The lubricant composition of claim 1, wherein the neopentyl polyhydric alcohol is selected from the group consisting of monopentaerythritol and trimethylolpropane.

15. The lubricant composition of claim 1, wherein the dicarboxylic acid is selected from the group consisting of hexanedioic acid, phthalic acid, isophthalic acid, terephthalic acid, cyclohexanedicarboxylic acid, and tetrahydrophthalic acid.

16. The lubricant composition of claim 6, wherein the antioxidant is present at a level from about 0.5 to about 4 percent by weight, and comprises at least one amine selected from the group consisting of benzenamine, N-phenyl-, reaction products with 2,4,4-trimethylpentane; N-phenyl-1,1,3,3-tetramethylbutylnaphthalen-1-amine; butylated hydroxytoluene; alkylated diphenylamine; nonylated diphenylamine; styrenated diphenylamine; hindered alkylphenols; benzenepropanoic acid, 3,5-bis(1,1-dimethylethyl)-4-hydroxy-, thiodi-2,1-ethanediyl ester; benzenepropanoic acid, 3,5-bis(1,1-dimethylethyl)-4-hydroxy-, 2,2-bis[[3-[3,5-bis(1,1-dimethylethyl)-4-hydroxyphenyl]-1-oxopropoxy]methyl]-1,3-propanediyl ester; and thiphenolic derivatives.

17. The lubricant composition of claim 7, wherein the extreme pressure/antiwear agent is present at a level from about 0.1 to about 2 percent by weight, and comprises at least one compound selected from the group consisting of t-butylphenyl phosphates, amines, C11-14-branched alkyl, monohexyl and dihexyl phosphates, isopropylphenylphoshates, tricresyl phosphates, trixylyl phosphates, di(n-octyl)phosphite, alkylated triphenylphosphorothionate, and triphenylthiophosphate.

18. The lubricant composition of claim 8, wherein the metal deactivator is present at a level from about 0.05 to about 1 percent by weight, and comprises at least one compound selected from the group consisting of benzotriazole and tolyltriazole.

19. The lubricant composition of claim 1, wherein the polyol polyester polymer is present at a level from about 1 to about 90 percent by weight, and comprises at least one ester formed from the reaction of trimethylolpropane, monopentaerythritol, dipentaerythritol, and tripentaerythritol with at least one carboxylic acid containing from 5 to 12 carbon atoms.

20. The lubricant composition of claim 19, wherein the carboxylic acid is linear or branched.

21. A method of lubricating a conveyored oven chain comprising:
a) providing the lubricant composition of claim 1; and
b) applying the lubricant composition to the conveyored oven chain.

22. The method of claim 21, wherein applying the lubricant composition comprises spraying, dipping, brushing, or manually applying the lubricant composition to the conveyored oven chain.

23. A process for producing a high temperature lubricant composition comprising:
a) providing a polyol polyester polymer obtained by the reaction of a neopentyl polyhydric alcohol, a dicarboxylic acid containing from 3 to 8 carbon atoms and a monofunctional carboxylic acid, in the presence of a metal catalyst and activated charcoal, at a temperature between about 180° C. and about 250° C.;
b) purifying the polyol polyester polymer through steam distillation and filtration; and
c) adding a high temperature additive.

24. The process of claim 23, wherein the neopentyl polyhydric alcohol contains from 3 to 8 hydroxyl groups, the dicarboxylic acid comprises hexanedioic acid and the monocarboxylic acid contains from 5 to 12 carbon atoms.

25. The process of claim 23, wherein the lubricant composition has a kinematic viscosity at 40° C. of from about 50 to about 1,000 centistokes, a viscosity index of at least about 140, and a flash point of at least about 270° C.

26. The process of claim 23, wherein the neopentyl polyhydric alcohol is selected from the group consisting of monopentaerythritol and trimethylolpropane.

27. The process of claim 23, wherein the dicarboxylic acid is selected from the group consisting of hexanedioic acid, phthalic acid, isophthalic acid, terephthalic acid, cyclohexanedicarboxylic acid, and tetrahydrophthalic acid.

28. The process of claim 23, wherein the polyol polyester polymer is present at a level from about 1 to about 90 percent by weight, and comprises at least one ester formed from the reaction of trimethylolpropane, monopentaerythritol, dipentaerythritol, and tripentaerythritol with at least one carboxylic acid containing from 5 to 12 carbon atoms.

29. The process of claim 28, wherein the carboxylic acid is linear or branched.
